(19) United States
(12) Patent Application Publication
(10) Pub. No.: US 2004/0005256 A1
(43) Pub. Date: Jan. 8, 2004

(54) Crystallization system utilizing atomization

(76) Inventors: Chenkou Wei, Princeton Junction, NJ (US); Margaret M. Gleeson, Monmouth Junction, NJ (US); Otute Akiti, Plainsboro, NJ (US)

Correspondence Address: STEPHEN B. DAVIS, BRISTOL-MYERS SQUIBB COMPANY, PATENT DEPARTMENT, P O BOX 4000, PRINCETON, NJ, 08543-4000, US

(21) Appl. No.: 10/419,418

(22) Filed: Apr. 21, 2003

Related U.S. Application Data
(60) Provisional application No. 60/376,414, filed on Apr. 29, 2002.
(60) Provisional application No. 60/439,066, filed on Jan. 9, 2003.

(51) Int. Cl. B01D 9/00; C13K 1/10

(52) U.S. Cl. 422/245.1; 23/295 R

(57) ABSTRACT

Crystallization of an organic pharmaceutical compound is achieved by atomization of one solution and introduction of the atomized solution into a vessel containing a second solution where the solutions are mixed to form a product. The process can be performed on non-reactive constituents such as a solution containing the compound to be crystallized dissolved in a solvent and an anti-solvent solution. Alternatively, the process can be performed on reactive constituents, such as solutions of solvents containing different reactive intermediates, under proper reactive conditions. The process may be practiced continuously or in batch mode. Atomizers of the non-pressure-driven ultrasonic type or of the ultrasonic or non-ultrasonic pressure-driven type can be utilized.

This application claims a benefit of priority from U.S. Provisional Application No. 60/376,414, filed on Apr. 29, 2002 and No. 60/439,066, filed on Jan. 9, 2003, the entire disclosures of which are herein incorporated by reference.

### BACKGROUND OF THE INVENTION

1. Field of the Invention

The present invention relates to a system for crystallization of organic pharmaceutical compounds and more particularly to a crystallization process that utilizes atomization and to the apparatus for practicing such a process.

It is well known in the pharmaceutical industry that the bioavailability of a sparingly soluble organic compound is often enhanced when the compound is very pure and the molecules of the compound have a small, uniform particle size, high surface area and short dissolution time. Purification can be accomplished by crystallization of the compound from solution. However, when crystallization takes place directly in a high supersaturation environment, the resulting material is often unsatisfactory due to low purity, high friability and lack of stability because the crystal structure formation is inadequate. Further, oils commonly produced during processing of supersaturated material may solidify without sufficient structure.

It is possible to slow down the crystallization process to obtain a higher purity, more stable product. However, slowing the process decreases crystallizer productivity and produces particles that are too large, having low surface area. Such particles require high intensity milling to create a useable product.

2. Description of Related Art

To overcome those problems, and provide particles of high surface area, high chemical purity and high stability, without the need for post-crystallization milling, a crystallization process, known as the “impinging fluid jet” process, has been developed.

One well known version of the “impinging fluid jet” process is disclosed in detail in U.S. Pat. No. 5,314,506 entitled “Crystallization Method To Improve Crystal Structure And Size” issued May 24, 1994, to Midler, et al, owned by Merek & Co., of Rahway, N.J. The reader is referred to that patent for background information and details of the process.

Basically, the impinging fluid jet process, as it is disclosed in U.S. Pat. No. 5,314,506, utilizes a supersaturated solution of the compound to be crystallized in solvent and an appropriate “anti-solvent” solution. Diametrically opposed high velocity jet streams of the solutions are formed and micro mixed in a jet chamber. The mixed solutions are then transferred into a vessel where they are stirred to produce the end product. The product, such as a neutral molecule or a salt, is crystallized out by mixing the solutions which reduces the solubility of the compound in the solvent mixture.

The impinging fluid stream process has also been used for conducting reactive crystallization wherein a chemical reaction and controlled crystallization take place simultaneously. The reader is directed to Patent Application Publication No.: U.S. 2002/0016498 A1 of Feb. 7, 2002, entitled “Reactive Crystallization Method to Improve Particle Size”, in the name of Am Ende et al., owned by Pfizer Inc., for further information in this regard.

Reactive crystallization involves two reactive intermediates. Fluid streams of solutions of the reactive intermediates are impinged in a chamber under appropriate reactive conditions. For example, a first solution containing one reagent (such as an acid) in a solvent is reacted with a second solution containing another reagent (such as a base) in a solvent are reacted to form a product, such as a salt. The product is not soluble in the solvent mixture and thus it rapidly crystallizes out. In the pharmaceutical industry, the drug substance is often in a salt form, so reactive crystallization is commonly used.

The impinging fluid jet process produces a satisfactory result in terms of purity, particle size and stability. However, several major drawbacks of this process have been observed. For example, the nozzles used to form the fluid streams must be very accurately aligned so that the streams impinge correctly. The ratio of the flow rate of the two streams is limited by the size of the nozzles. The process cannot be used for low flow rates as the impingement would not offer a sufficient degree of mixing. Further, the apparatus used to practice the process is time consuming to set up and difficult to control.

We have developed a different crystallization system that can be used with both non-chemically reactive constituents and chemically reactive constituents which overcomes the drawbacks of the impinging fluid jet process by eliminating the need for forming high velocity fluid streams and for accurately aligning the nozzles. In our system, the ratio of the flow rates are not limited by the nozzle size and low flow rates can be accommodated. Moreover, the apparatus used to perform the process is easy to set up and control

### BRIEF SUMMARY OF THE INVENTION

Our system produces particles of purity, surface area and stability that are comparable to or better than those obtained with the impinging fluid jet process. Like the impinging fluid jet process, our product does not require post-crystallization milling.

Our process works particularly well on compounds that crystallize quickly. This is because mixing and crystallization take place simultaneously. Further, our process can be practiced continuously or in a batch mode.

Our process utilizes a conventional atomizer instead of fluid jet nozzles. A first solution is supplied to the atomizer. The atomizer creates a fine mist of droplets of the first solution. The droplets are introduced into a second solution. The atomized solution and the second solution are mixed to produce the crystallized product.

When non-chemically reactive constituents are combined, the first solution may be a solution containing the material to be crystallized, such as a neutral molecule or a salt, dissolved in a solvent. The material-containing solution is atomized and the droplets are introduced into and mixed with the second solution, which is a solution containing an anti-solvent. Mixing the solutions reduces the solubility of the material, causing it to crystallize out.

The process may also be used for reactive crystallization, for example, to prepare pharmaceutical salts. In that case, the first solution contains a first reactive intermediate, such as an acid, in a solvent and the second solution contains a second reactive intermediate, such as a base, in a solvent. The atomized solution and the second solution are mixed under conditions of temperature and pressure that permit reaction of the first and second reactive intermediates. The product has limited solubility in the solvent mixture and thus rapidly crystallizes out as the solutions are mixed.

As used herein, the terms “first” and “second” are not intended to denote order or to limit the invention to a particular sequence of the combination of the constituents. Further, the term “solution” is used generically and should be understood to include dispersions, emulsions, multi-phase systems and pure solvents, as well as solutions.

Our process can be performed utilizing a conventional non-pressure-driven ultrasonic atomizer. That type of atomizer has proved very effective when relatively small quantities are involved, such as in the laboratory. However, in manufacturing situations, where larger quantities must be produced, we have found that pressure-driven atomizers are more suitable. Accordingly, we describe the implementation of our crystallization process herein using both types of atomizers.

It is, therefore, a prime object of the present invention to provide a system for crystallizing an organic pharmaceutical compound using atomization which results in particles of high purity, high stability and high surface area, without the necessity of post-crystallization milling.

It is another object of the present invention to provide a system for crystallizing an organic pharmaceutical compound using atomization wherein the necessity for critical alignment of impinging fluid jet streams is entirely eliminated.

It is another object of the present invention to provide a system for crystallizing an organic pharmaceutical compound using atomization wherein the ratio of the solutions fed to the apparatus can be easily controlled.

It is another object of the present invention to provide a system for crystallizing an organic pharmaceutical compound using atomization wherein the apparatus for performing the process can be set up relatively rapidly.

It is another object of the present invention to provide a system for crystallizing an organic pharmaceutical compound using atomization that can be used in a continuous or batch mode.

It is another object of the present invention to provide a system for crystallizing an organic pharmaceutical compound using atomization that can be used with non-chemically reactive constituents or chemically reactive constituents.

It is another object of the present invention to provide a system for crystallizing an organic pharmaceutical compound using atomization that can be effectively utilized to produce small quantities of product for laboratory use or larger manufacturing quantities.

In accordance with one aspect of the present invention, a process is provided for crystallization of a chemical material from a first solution and a second solution. The first solution is atomized. The atomized solution is introduced into the second solution. The atomized solution and the second solution are then mixed to form the product.

When non-chemically reactive constituents are combined, the first solution may include the material to be crystallized dissolved in a solvent. The second solution may include a solution containing an anti-solvent.

When chemically reactive constituents are employed, the first solution may include a solvent and a first reactive intermediate. The second solution may include a solvent and a second reactive intermediate. The solutions are combined under conditions of temperature and pressure that permit the first and second reactive intermediates to form a product of limited solubility in the solvent mixture.

In accordance with another aspect of the present invention, a process is provided for crystallization of a chemical material from a solution containing the compound to be crystallized dissolved in a solvent and a solution including an anti-solvent. The material-containing solution is atomized. The atomized solution is introduced into the anti-solvent solution. The atomized solution and the anti-solvent solution are then mixed to form the product.

In accordance with another aspect of the present invention, a process is provided for crystallization of a chemical material from a first solution including a solvent and a first reactive intermediate and a second solution including a solvent and a second reactive intermediate. The first solution is atomized. The atomized solution is introduced into the second solution. The solutions are mixed under conditions of temperature and pressure that permit reaction of the first and second reactive intermediates to form a product of limited solubility in the solvent mixture.

The first solution is atomized using an atomizer. Preferably, the atomizer is an atomizer of the non-pressure-driven ultrasonic type. Alternatively, an atomizer of the pressure-driven type can be employed. The atomizer has an inlet that is connected to receive the first solution. The atomizer also has an outlet.

The atomized solution may be introduced into the second solution by locating the atomizer outlet above the surface of the second solution. However, in some situations, it may be preferable to locate the atomizer outlet below the surface of the second solution such that immediate contact between the droplets of the first solution and the second solution is achieved.

The step of atomizing the first solution is performed by supplying the first solution to the atomizer inlet. This can be accomplished using a pump.

The atomizer can be controlled to vary the droplet size. The step of atomizing the first solution preferably includes the step of adjusting the atomizer to produce a fine mist at the outlet.

The step of mixing the atomized solution and second solution includes stirring or agitating the mixture. This can be accomplished by any conventional agitation mechanism, such as a mechanical or magnetic stirrer.

In one preferred form, the process comprises the steps of continuously introducing the first solution into the mixture and continuously removing the mixed product. In this manner, the crystallization process can be performed continuously.

In accordance with another aspect of the present invention, apparatus is provided for crystallization of a chemical material from a first solution and a second solution. The apparatus includes means for atomizing the first solution and for introducing the atomized solution into the second solution. The atomized solution and the second solution are mixed to produce the product.

When non-chemically reactive constituents are combined, the first solution may include the material to be crystallized dissolved in a solvent. The second solution may include a solution including an anti-solvent.

When chemically reactive constituents are employed, the first solution may include a solvent and a first reactive intermediate. The second solution may include a solvent and a second reactive intermediate. The atomized solution and the second solution are mixed under conditions of temperature and pressure that permit the reactive intermediates to produce a product of limited solubility in the solvent mixture.

In accordance with another aspect of the present invention, apparatus is provided for crystallization of a chemical material from a solution including the material to be crystallized dissolved in a solvent and a solution including an anti-solvent. The apparatus includes means for atomizing the material-containing solution and for introducing the atomized solution into an anti-solvent solution. Means are also provided for mixing the atomized solution and the anti-solvent solution to form the product.

In accordance with another aspect of the present invention, apparatus is provided for crystallization of a chemical material from a first solution including a solvent and a first reactive intermediate and a second solution including a solvent and a second reactive intermediate. The apparatus includes means for atomizing the first solution and for introducing the atomized solution into the second solution. Means are provided for mixing the atomized solution and the second solution under conditions of temperature and pressure that permit reaction of the first and second reactive intermediates to produce a product of limited solubility in the solvent mixture.

The atomizing means may take the form of a non-power driven ultrasonic atomizer. Alternatively, the atomizing means may be a power driven atomizer. In the latter case, means for providing pressurized gas to the atomizer are provided.

The atomizing means may introduce the atomized solution above the surface of the second solution. Alternatively, the atomized solution may be introduced below the surface of the second solution.

The first solution is supplied to the atomizing means. Means, such as a pump, may be provided for this purpose.

The means for mixing the atomized solution and the second solution includes means for stirring the solutions.

Means may be provided for continuously introducing the second solution. In that case, means for continuously removing the product are also provided.

Preferably, a vessel is provided. The second solution is introduced into the vessel. The atomized solution and the second solution are mixed in the vessel.

The atomizing means has an inlet connected to receive the first solution. The atomizing means also has an outlet situated to introduce the atomized solution into the second solution.

The atomizing means outlet may be located above the surface of the second solution. Alternatively, the atomizer means outlet may be located below the surface of the second solution.

The atomizing means includes means for varying the droplet size. This means is adjusted to produce a fine mist at the outlet.

The means for mixing the atomized solution and the second solution includes means for stirring the solutions in the vessel.

The apparatus further includes means for continuously introducing the second solution into the vessel. Means are also provided for continuously removing the product from the vessel.

### BRIEF DESCRIPTION OF THE SEVERAL VIEWS OF THE DRAWINGS

To these and to such other objects which may hereinafter appear, the present invention relates to a crystallization system using atomization, as disclosed in detail in the following specification, and recited in the annexed claims, taken together with the accompanying drawings, in which like numerals relate to like parts and in which:

FIG. 1 is a drawing schematically illustrating a first preferred embodiment of apparatus suitable for practicing the crystallization process of the present invention with non-reactive constituents in the continuous mode; and

FIG. 2 is a drawing schematically illustrating a second preferred embodiment of apparatus suitable for practicing the crystallization process of the present invention with non-reactive constituents in the batch mode;

FIG. 3 is a drawing schematically illustrating a third preferred embodiment of the apparatus suitable for practicing the crystallization process of the present invention with reactive constitutents, in the continuous mode; and

FIG. 4 is a drawing schematically illustrating a fourth preferred embodiment of the apparatus suitable for practicing the crystallization process of the present invention with reactive constituents, in the batch mode.

The process of the present invention can be performed with non-reactive constituents where a first solution containing the material to be crystallized is atomized and introduced into a second, anti-solvent solution. When the atomized material-containing solution is mixed with the anti-solvent solution, the solubility of the compound in the mixed solutions is limited, causing the material to crystallize out.

For example, the material-containing solution may be composed of a solvent, such as water, and a material to be crystallized, such as D,L-Threonine, dissolved in the water. The anti-solvent could be acetone. The solid D,L-Threonine is dissolved at its maximum concentration ratio (160 g/L) in water. The D,L-Threonine solution is atomized and introduced into the acetone. The atomized solution and the acetone are then mixed to produce the crystallized product.

The process of the present invention can also be utilized when chemically reactive constituents are involved. Such reactive crystallization is commonly used in the pharmaceutical industry to prepare salts. In this process, the first solution contains a first reactive intermediate, such as an acid, in a solvent. The second solution contains a second reactive intermediate, such as a base, in a solvent. The solvents may be the same or different. The first solution is atomized and introduced into the second solution. The solutions are mixed under conditions of temperature and pressure that permit reaction of the first and second reactive intermediates to produce a product of limited solubility in the solvent mixture.

For example, the first solution could be the free base 1-(3′-aminobenzisoxazol 5′-yl)-3-trifluoronmethyl-5-[[4-[2′-dimethylaminomethyl) imidazol-1′-yl]-2-fluorophenyl]aminocarbgonyl]pyrazole dissolved in ethanol at 70 deg. C. The acid HCl, dissolved in isopropyl alcohol at 65 deg. C, could be the second solution. The first solution is atomized and introduced into the second solution. The two solutions are mixed. The salt 1-(3′-aminobenzisoxazol-5′-yl)-3 trifluoromethyl-5-[[4-[(2′-dimethylaminomethly)imidazol-1′yl]-2-fluorophenyl]aminocarbonyl]pyrazole. HCl is formed.

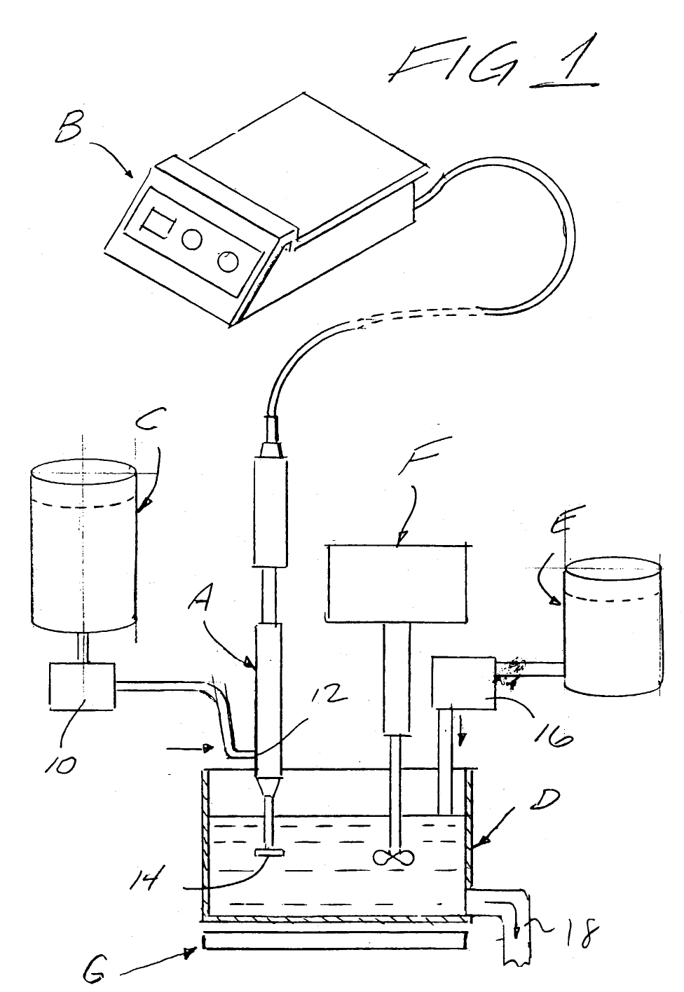

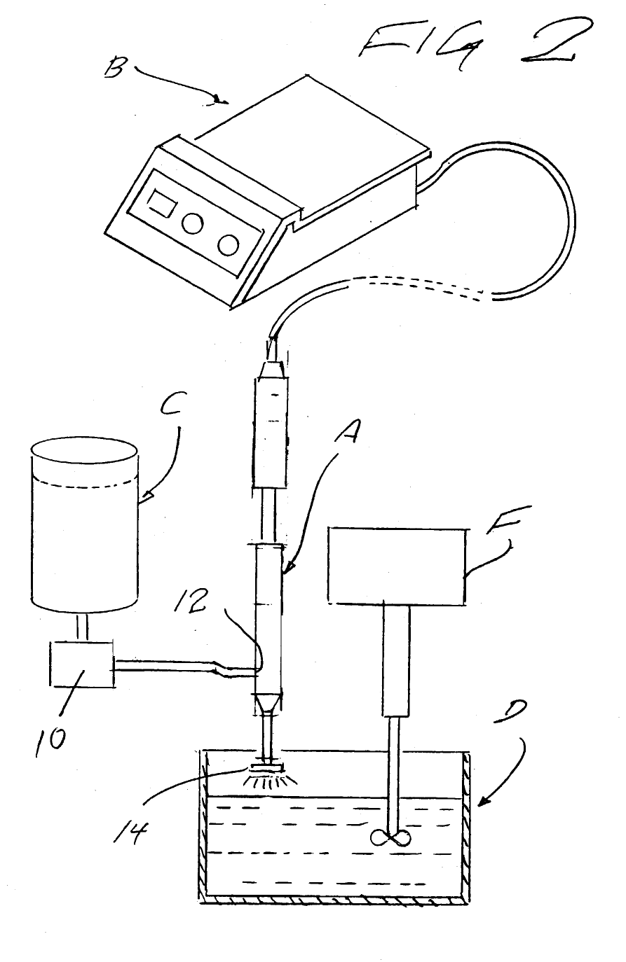

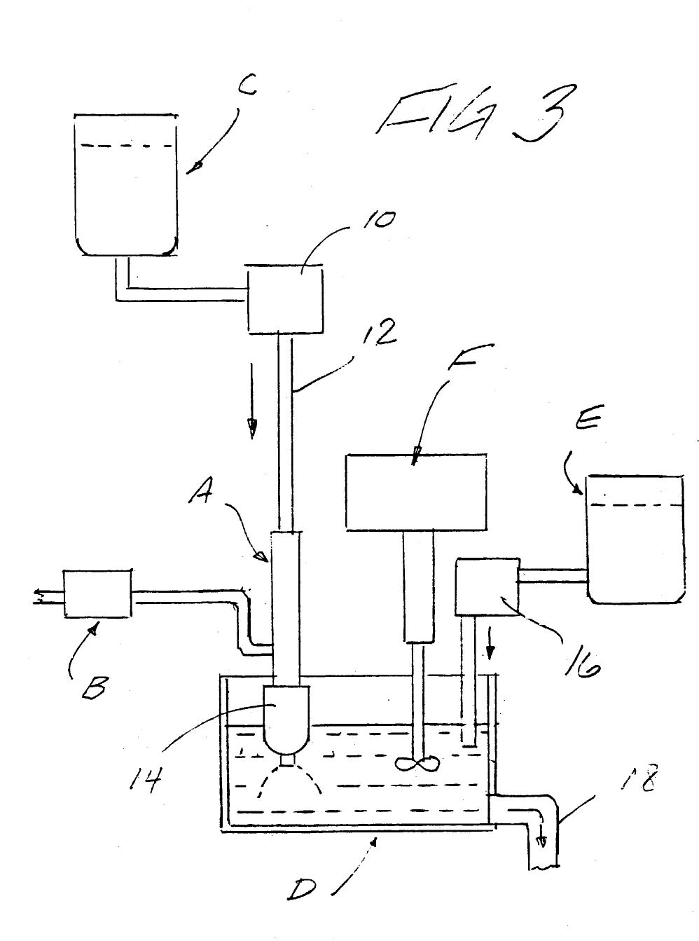

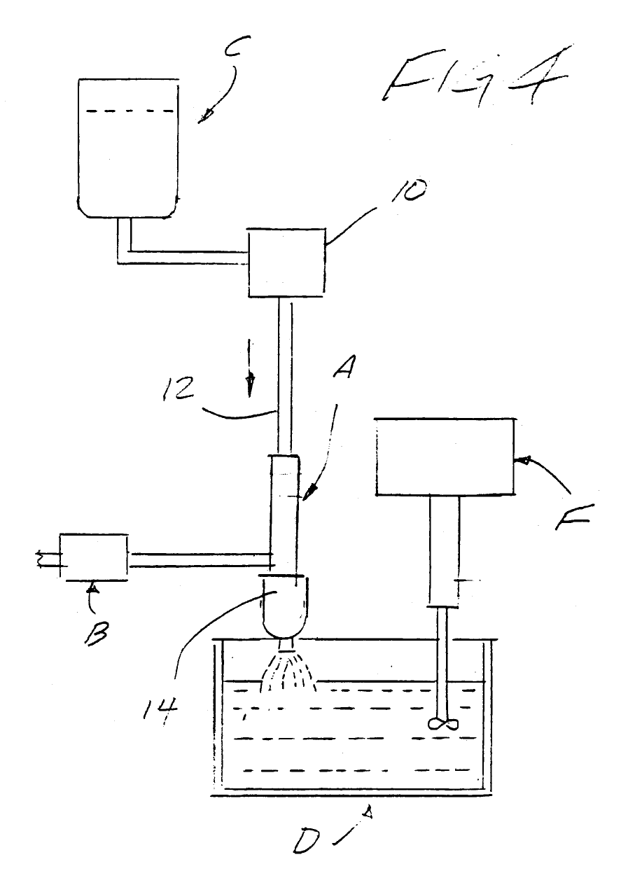

The process of the present invention can be implemented as a continuous process, as illustrated in FIGS. 1 and 3, or as a batch process, as illustrated in FIGS. 2 and 4. Whether performed continuously or in batch mode, the basic process is the same.

In one preferred form, the process of the present invention utilizes a conventional ultrasonic non-pressure-driven atomizer as illustrated in FIGS. 1 and 2. The ultrasonic atomizer is most suitable for producing non-manufacturing quantities, such as laboratory usage.

One ultrasonic atomizer that has performed well in this regard is Model VC 130 AT/VC 134 AT, manufactured by Sonics & Materials, Inc., 53 Church Hill Road, Newtown, Conn. 06470-1614. However, other commonly available ultrasonic atomizers could also be used.

As shown in FIGS. 1 and 2, the ultrasonic atomizer includes a nozzle, generally designated A, and a control unit, generally designated B. The atomizer creates a fine mist of the first solution at the nozzle outlet 14.

The first solution is pumped, by a pump 10, from a first supply vessel, generally designated C, to the inlet 12 of atomizer nozzle A.

The atomizer uses low ultrasonic vibrational energy for atomization. The liquid can be dispensed to the atomizing nozzle by either gravity feed or a small low-pressure metering pump, such as pump 10. Atomization can be accomplished continuously or intermittently. Because the aperture at the nozzle outlet 14 is relatively large (2.3 mm), clogging is not a problem.

The ultrasonic power supply in unit B converts 50/60 Hz to high frequency electrical energy. This electrical energy is transmitted to a piezoelectric transducer within nozzle A, where it is changed to mechanical vibrations. The ultrasonic vibrations are intensified by the nozzle and focused at the outlet 14 where the atomization takes place. The liquid travels through the nozzle, and spreads out as a thin film on the atomizing surface. The oscillation at the outlet 14 disintegrates the liquid into microdroplets and then ejects them to form a gentle, low viscosity mist.

The droplet size is dependent upon the frequency of the ultrasonic vibrations. The higher the frequency of the vibrations, the smaller the droplet size. The medium droplet size is 90 microns at 20 KHz and 45 microns at 40 KHz. Preferably, the frequency of the atomizer, and hence the droplet size, can be adjusted. Flat or conical nozzle outlets 14 can be employed.

The atomized solution is introduced into the second solution in a crystallization vessel, generally designated D. The second solution may be continuously pumped, by a second pump 16, into the crystallization vessel from a second supply vessel, generally designated E. Vessel D may be open. Alternatively, vessel D may be closed to maintain a particular pressure therein. Vessel D may be associated with a means of adjusting the temperature of the contents, generally designated G. Accordingly, the temperature and pressure in vessel D may be adjusted to maintain the appropriate reactive conditions.

The nozzle outlet 14 can be located below the surface of the second solution in vessel D, as shown in FIG. 1 or may be located just above the surface of the second solution, as shown in FIG. 2. However, with this type of atomizer, it is preferred to locate the outlet below the surface of the second solution because the resulting particles are smaller and more uniform in size. This is believed to be a result of the immediate contact between the droplets and the second solution.

The solutions within vessel D are continuously mixed such that mixing and crystallization occurs simultaneously. This can be accomplished by any conventional mixing or agitation mechanism, such as a mechanical or magnetic mixer, generally designated F.

In the continuous process of FIG. 1, the second solution is continuously pumped into vessel D by pump 16. The crystallized product is continuously removed from vessel D through a discharge conduit 18. The flow rates of the solutions and thus the solution ratio, are accurately controlled by pumps 10 and 16

FIG. 2 illustrates the process using the non-pressure-driven atomizer, as performed in batch mode. The same atomizer, including nozzle A and control unit B, first solution supply vessel C, pump 10, and mixer F are utilized. However, in this embodiment, the second solution is not fed to vessel D continuously but instead is placed in the vessel prior to introduction of the atomized solution. Further, the crystallized product is not continuously removed from the crystallization vessel.

In the reactive crystallization situation, the reaction between the first reactive intermediate and the second reactive intermediate must take place under the appropriate temperature and pressure conditions. If other than the ambient temperature is required, the temperature of the individual solutions can be altered by heating or cooling the solutions separately in the supply vessels C, E as needed, or by heating or cooling the mixture in the crystallization vessel D, as indicated above. If other than atomospheric pressure is required, crystallization vessel D can be a closed vessel and the internal pressure maintained as needed.

Further, when the apparatus is used for reactive crystallization, it is important that all components that come in contact with the constituents be chemically compatible with those constituents to avoid corrosion and contamination.

FIGS. 3 and 4 illustrate a preferred embodiment of the invention where the process is performed with an ultrasonic or non-ultrasonic pressure-driven atomizer, particularly well suited for production quantities. FIG. 3 illustrates the process in the continuous mode. FIG. 4 illustrates the process in the batch mode.

The process can be used with non-reactive constituents or with reactive constituents, as described above. In the latter case, temperature and pressure conditions in vessel D may have to be set to permit the reaction to take place. Further, the wetted parts of the equipment must be selected so as to be chemically compatible with the reagents and solvents employed.

The pressure-driven atomizer employed is preferably a high energy, gas driven sonic generator with an internal liquid distribution system. It may utilize a spray nozzle such as is available from Misonix, Incorporated, 1938 New Highway, Farmingdale, N.Y. 11735 under the trademark SONIMIST.

The SONIMIST nozzle, generally designated A′, is energized by compressed air or other pressurized inert gas, such as nitrogen, fed to it from a compressor or other compressed gas supply, generally designated B′. There is no piezoelectric effect and no electricity is needed. A sonic field is created at the outlet of the nozzle as the compressed gas accelerates and reaches the speed of sound.

The first solution is fed to the nozzle inlet 12′ from a supply pump 10 fed from supply vessel C. The solution enters the sonic field where constant frequency sound waves provide a chopping action, breaking the liquid stream into an aerosol. The particle size generated is a function of fluid flow rate, fluid pressure, orifice size and the size of the resonator chamber which forms part of nozzle A′. Close control of the droplet size is possible. Further, by modifying the size of the resonator gap in the nozzle outlet 14, the spray pattern can be changed.

Another nozzle that has been used successfully is available from Spraying Systems Co., P 0.0. Box 7900, Wheaton, Ill., 60189. The Spraying Systems Co. nozzle is an air atomizing nozzle. That type of nozzle produces a fine spray by mixing compressed air with the liquid to be atomized. The liquid is siphoned in by the compressed air and therefore a pump is not needed.

The atomized solution from nozzle A′ is introduced into the second solution in vessel D. The nozzle outlet 14 can be positioned above or below the surface of the second solution. However, we have found that the pressure-driven atomizer works best when nozzle outlet 14 is located above the surface of the liquid in vessel D. When so located, the distance between the nozzle outlet and the liquid surface may vary the particle size.

The remaining portions of the apparatus as depicted in FIGS. 3 and 4 are the same, and operate the same, as corresponding elements in FIGS. 1 and 2. FIG. 3 depicts the system employing the pressure-driven atomizer in the continuous mode application. FIG. 4 depicts the pressure-driven atomizer in a batch mode. In the reactive crystallization situation, a closed crystallization vessel D may be employed and appropriate temperature and pressure conditions maintained as previously described.

It will now be appreciated that the present invention is a system in which pure organic pharmaceutical compounds with high bioavailability are produced through crystallization using atomization. The resulting product has molecules of small, uniform particle size, high surface area and short dissolution time, which do not require post-production milling.

The process is performed using an atomizer that creates a fine mist of droplets of a first solution. The droplets are introduced into a second solution and the solutions are mixed. The process can be performed continuously or on a batch basis. It can be performed with chemically non-reactive constituents or chemically reactive constituents. No nozzle clogging or alignment problems are encountered. Solution flow rates and the solution ratio are accurately controlled. The apparatus can be set up in an efficient manner.

While only a limited number of preferred embodiments of the present invention have been disclosed for purposes of illustration, it is obvious that many variations and modifications could be made thereto. It is intended to cover all of these variations and modifications that fall within the scope of the present invention, as defined by the following claims.

We claim:

1. A process for crystallization of a chemical material from a first solution and a second solution, the process comprising the steps of: atomizing the first solution; introducing the atomized solution into the second solution; and mixing the atomized solution and the second solution to form the product.

2. The process of claim 1 wherein the first solution comprises the material to be crystallized dissolved in a solvent and the second solution comprises an anti-solvent.

3. The process of claim 1 wherein the first solution comprises a solvent and a first reactive intermediate and the second solution comprises a solvent and a second reactive intermediate.

4. The process of claim 3 wherein the step of mixing comprises the step of mixing the solutions under conditions of temperature and pressure that permit the first and second reactive intermediates to react to form a product of limited solubility in the solvent mixture.

5. A process for crystallization of a chemical material from a first solution containing the material to be crystallized dissolved in a solvent and a second solution comprising an anti-solvent, the process comprising the steps of: atomizing the first solution; introducing the atomized solution into the second solution; and mixing the atomized solution and the second solution to form the product.

6. A process for crystallization of a chemical material from a first solution comprising a first reactive intermediate and a solvent, and a second solution comprising a second reactive intermediate and a solvent, the process comprising the steps of: atomizing the first solution; introducing the atomized solution into the second solution; and mixing the atomized solution and the second solution under conditions of temperature and pressure that permit reaction of the first and second reactive intermediates to produce a product of limited solubility in the solvent mixture.

7. The process of claim 1 wherein the step of atomizing the first solution comprises the step of atomizing the first solution using an ultrasonic atomizer.

8. The process of claim 1 wherein the step of atomizing the first solution comprises the step of atomizing the first solution using a power driven atomizer.

9. The process of claim 8 further comprising the step of providing a pressurized gas to the atomizer.

10. The process of claim 1 further comprising the step of introducing the second solution into a vessel.

11. The process of claim 10 wherein the step of mixing the solutions takes place in a vessel.

12. The process of claim 1 wherein the step of introducing the atomized solution comprises the step of introducing the atomized solution below the surface of the second solution.

13. The process of claim 1 wherein the step of introducing the atomized solution comprises the step of introducing the atomized solution above the surface of the second solution.

14. The process of claims 1 wherein the step of atomizing the first solution comprises the step of supplying the first solution to the atomizer.

15. The process of claim 1 wherein the step of atomizing comprises the step of adjusting the atomizer to produce a fine mist.

16. The process of claim 1 wherein the step of mixing the atomized solution and second solution comprises the step of stirring the solutions.

17. The process of claim 10 further comprising the step of continuously introducing the second solution into the vessel.

18. The process of claim 17 further comprising the step of continuously removing the product from the vessel.

19. The process of claim 3 wherein one of the first and second reactive intermediates is an acid and the other of the first and second reactive intermediates is a base.

20. Apparatus for crystallization of a chemical material from a first solution and a second solution, the apparatus comprising: means for atomizing the first solution and for introducing the atomized solution into the second solution; and means for mixing the atomized solution and the second solution to form a product.

21. The process of claim 20 wherein the first solution comprises the material to be crystallized dissolved in a solvent and the second solution comprises an anti-solvent.

22. The process of claim 20 wherein the first solution comprises a solvent and a first reactive intermediate and the second solution comprises a solvent and a second reactive intermediate.

23. The process of claim 22 wherein the step of mixing comprises the step of mixing the solutions under conditions of temperature and pressure that permit the first and second reactive intermediate to react to form a product of limited solubility in the solvent mixture.

24. Apparatus for crystallization of a chemical material from a first solution containing the material to be crystallized dissolved in a solvent and a second solution comprising an anti-solvent, the apparatus comprising: means for atomizing the first solution and for introducing the atomized solution into the second solution; and means for mixing the atomized solution and the second solution to form the product.

25. Apparatus for crystallization of a chemical material from a first solution comprising a first reactive intermediate and a solvent and a second solution comprising a second reactive intermediate and a solvent, the apparatus comprising: means for atomizing the first solution and for introducing the atomized solution into the second solution; and means for mixing the atomized solution and the second solution under conditions of temperature and pressure which permit reaction of the first and second reactive intermediates to produce a product of limited solubility in the solvent mixture.

26. The apparatus of claim 20 wherein said atomizer means comprises an ultrasonic atomizer.

27. The apparatus of claim 20 wherein said atomizer means comprises a pressure driven atomizer.

28. The apparatus of claim 27 further comprising means for supplying pressurized gas to said atomizer.

29. The apparatus of claim 20 wherein said atomizing means introduces the atomized solution below the surface of the second solution.

30. The apparatus of claim 20 wherein said atomizing means introduces the atomized solution above the surface of the second solution.

31. The apparatus of claim 20 further comprising means for supplying the first solution to said atomizing means.

32. The apparatus of claim 20 wherein said means for mixing the atomized solution and the second solution comprises means for stirring the solutions.

33. The apparatus of claim 20 further comprising means for continuously introducing the second solution.

34. The apparatus of claim 33 further comprising means for continuously removing the product.

35. The apparatus of claim 20 further comprising means for adjusting said atomizer means to product a fine mist.

36. The apparatus of claim 20 further comprising means for adjusting the temperature of the solutions.

37. The apparatus of claim 20 further comprising a vessel into which the second solution is introduced.

38. The apparatus of claim 37 wherein said mixing means mixes the solutions in said vessel.

39. The apparatus of claim 20 wherein said atomizer means comprises an inlet and further comprising means for supplying said inlet with the first solution.

40. The apparatus of claim 39 wherein said supplying means comprises a pump.

41. The apparatus of claim 20 wherein said atomizer means has an outlet.

42. The apparatus of claim 41 wherein said atomizer means outlet is located below the surface of the second solution.

43. The apparatus of claim 41 wherein said atomizer means outlet is located above the surface of the second solution.

44. The apparatus of claim 37 wherein said means for mixing comprises means for stirring the solutions in the vessel.

45. The apparatus of claim 37 further comprising means for continuously introducing the second solution into the vessel.

46. The apparatus of claim 45 further comprising means for continuously removing the product from the vessel.
